(19) United States
(12) Patent Application Publication
(10) Pub. No.: US 2004/0055433 A1
(43) Pub. Date: Mar. 25, 2004

(54) Test piece cutter and splitting method thereof

(75) Inventors: Chiao-Chung Huang, Dashi Jen (TW); Pei-Hsin Yu, Taoyuan City (TW); Yuting Chuang, Taitung City (TW)

Correspondence Address: Richard P. Berg, Esq., c/o LADAS & PARRY, Suite 2100, 5670 Wilshire Boulevard, Los Angeles, CA, 90036-5679, US

(73) Assignee: AU Optronics Corp.

(21) Appl. No.: 10/648,596

(22) Filed: Aug. 25, 2003

(30) Foreign Application Priority Data
Sep. 25, 2002 (TW) 91121993

(51) Int. Cl. B26D 1/00

(52) U.S. Cl. 83/13

(57) ABSTRACT

A precise cutting device for splitting a test piece. The device includes a microscope and a cutter. The microscope has a movable stage and a lens set. The stage supports the test piece. The lens set is adjustable to show the microstructure of the test piece. The cutter disposed under the stage of the microscope can pass through the opening of the stage to form notches on the surface of the test piece.

### BACKGROUND OF THE INVENTION

1. Field of the Invention

The present invention relates to an apparatus and method for precisely splitting a test piece.

2. Description of the Related Art

Semiconductor substrates are usually damaged by particles in the air, failure of fabrication apparatus, or operator fault. In order to increase the yield and reduce the cost, the defective substrates are usually scanned and analyzed to isolate the problem.

Focused ion beams (FIB) are usually used in conventional cross-section analysis. FIG. 1A shows a schematic view thereof, and FIG. 1B is a top view of the test piece shown in FIG. 1A. In FIGS. 1A and 1B, the conventional analysis method uses a focused ion beam 21 to form a groove 13 crossing over a defect P, or a target point, through the wiring layers 12 and the substrate 11. After that, an electron microscope 30 is used to obliquely scan the microstructure of the cross-section near the target point P. However, the ion beam producer 20 used in the conventional FIB method is very expensive, and its cutting speed is too slow (about 2-5 μm/hr) to form a groove longer than 20 mm.

Because the groove 13 is formed by ion beam 21 and not by cutting though the test piece 10, the electron beam 31 emitted by the electron microscope 30 can only scan the cross-section from an oblique direction in a predetermined range (19°-81°). Moreover, because the scanning direction is not perpendicular to the cross-section, the received images are not usually clear enough to distinguish each wiring layer.

### SUMMARY OF THE INVENTION

Accordingly, an object of the present invention is to provide a less expensive but precise cutter for glass test pieces which may have defects and require cross-section analysis.

Another object of the present invention is to provide a method using the cutter to split glass test pieces, such that the cross-section can be vertically observed by an electron microscope, receiving clear images.

The present invention provides a precise cutting device for splitting a test piece. The precise cutting device includes a microscope and a cutter. The microscope has a movable stage and a lens set. The stage supports the test piece. The lens set is adjustable to show the microstructure of the test piece. The cutter disposed under the stage of the microscope can pass through the opening of the stage to form notches on the surface of the test piece.

According to the present invention, the stage of the microscope has a clip to fix the test piece and a first position adjuster to shift the test piece horizontally within a predetermined area.

Moreover, the precise cutting device also has a second position adjuster disposed under the stage to elevate the vertical position of the cutter. The cutter has a diamond tip or a wheel knife at the tip thereof by which can form cuts on the surface of the test piece.

The precise cutting device of the present invention also has an image sensor and a monitor. The image sensor connects to the lens set to receive optical images near the target point on the surface of the test piece. The monitor is electrically connected to the image sensor, showing optical images received by the image sensor converts. The image sensor is a charge-coupled camera.

The present invention also provides a test piece splitting method for the precise cutting device. The method includes the steps of providing a test piece having a surface with a target point and fixed on the stage with the surface contacting the stage and the target point disposed within the range of the opening. The next step of the method is to adjust the amplification of the lens set to show a distinct view of the target point. A first notch and a second notch are formed on the surface. The first notch and the second notch are aligned with the target point in a predetermined line, and the distance between the neighboring end points is a first interval, 1 mm to 50 μm according to a preferred embodiment. Finally, the test piece is split along the predetermined line.

The method to form the notches includes the step of changing the vertical position of the tip of the cutter to contact the surface with target point. Next, the test piece disposed on the stage is moved by the first position adjuster to change the position of the tip to arrive at a first point on the surface. The cutter is raised a second distance, about 50 μm-10 μm, to cut into the test piece. The test piece is moved by the first position adjuster to form a first notch, and then lowering the cutter the second distance. Next, the test piece is moved by the first position adjuster to change the position of the tip to arrive at a second point on the surface. The cutter is raised to cut into the test piece again, forming a second notch.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a schematic view showing the conventional cross-section analysis method using a focused ion beam;

FIG. 1B is a top view of the test piece shown in FIG. 1A;

FIG. 2 shows the precise cutting device according to the present invention;

FIG. 3 shows the test piece clipped to the stage;

FIG. 4A is a side view of the cutter with a diamond tip in the first embodiment of the present invention;

FIG. 4B is a side view of the cutter with a wheel knife in the second embodiment of the present invention;

FIG. 5 is a schematic view of the test piece with notches;

FIG. 6 is a flowchart showing the test piece splitting method according to the present invention.

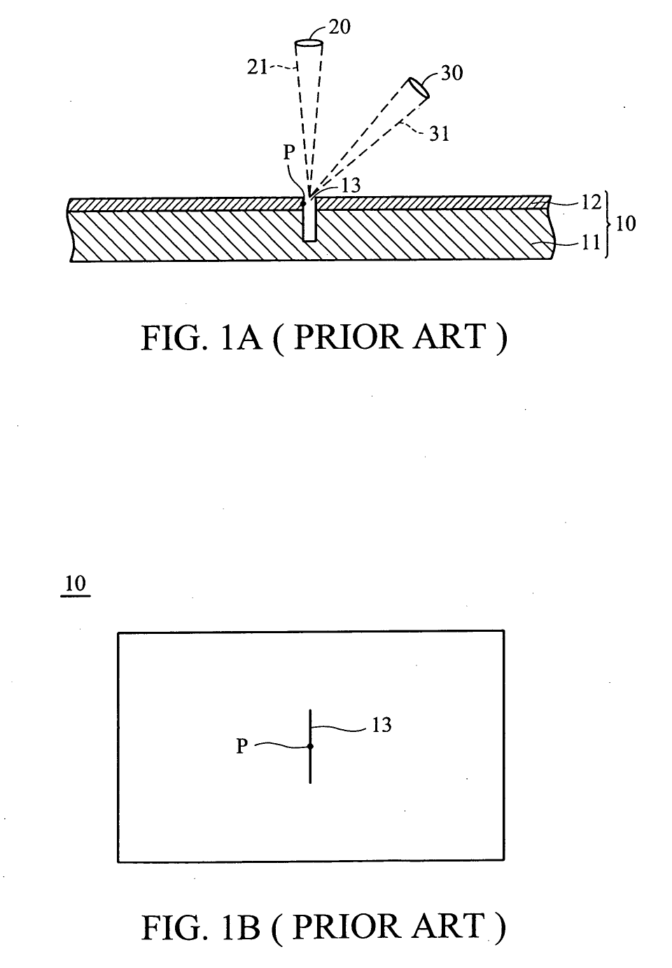

### DETAILED DESCRIPTION OF THE INVENTION

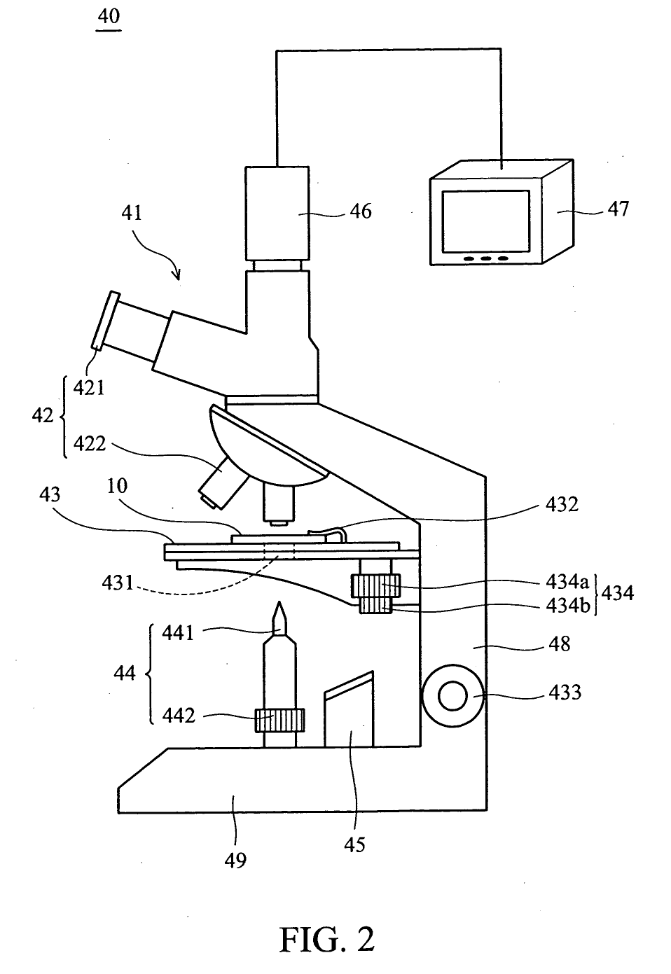

FIG. 2 shows the precise cutting device according to the present invention. The precise cutting device 40 includes a microscope 41 and an elevated cutter assembly 44. The microscope 40 has a movable stage 43, an adjustable lens set 42, and a light source 45. The stage 43 supports the test piece 10. The lens set 42 includes eyepieces 421 and objectives 422 to change the amplification of the microscope 41, showing the microstructure of the test piece 10. The light source disposed on the base 49 of the microscope 41 has a lamp facing the opening 431 of the stage 43 to light the test piece 10.

The cutter assembly 44 is disposed on the base 49 under the stage of the microscope and aligned with the opening 431. The cutter assembly 44 includes a second position adjuster 442 and an extendable cutter 441 disposed thereon. The second position adjuster 442 can be rotated to vertically raise or lower the cutter 441. The tip of the cutter 441 passes through through-hole 431 of the stage 43 contacting the bottom surface of the test piece 10 on the stage 43 to form notches. The precise cutting device 40 according to the present invention further includes an image sensor 46 and a monitor 47 to display a clear image of the test piece 10. The image sensor is a charge-coupled camera. The image sensor disposed on the eyepiece side of the lens set 42 electrically connects to the monitor 47, converting received optical images into electrical signals, such s that an enlarged view of the test piece 10 can be displayed on the monitor 47.

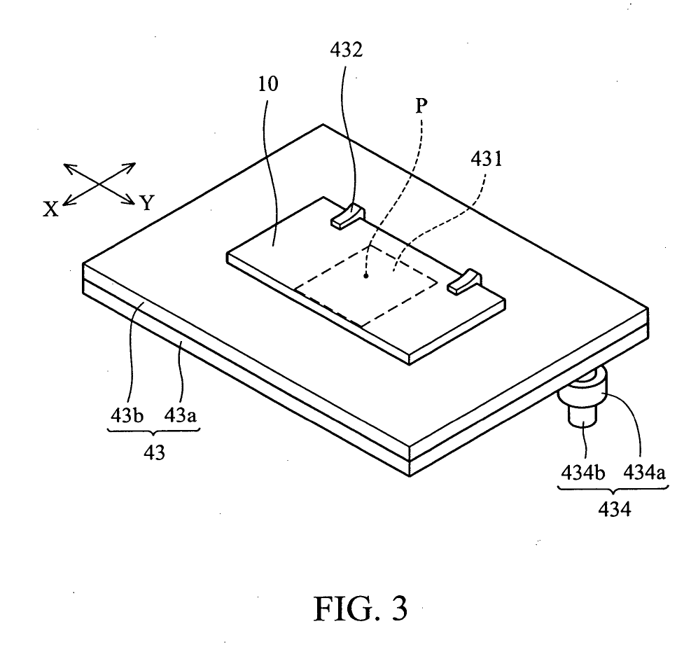

FIG. 3 shows the test piece clipped to the stage. In FIG. 3, the stage 43 of the microscope 41 includes a top plate 43a and an immovable bottom plate 43b. The top plate 43a and the bottom plate 43b each have an opening 431. The top plate 43a also has clips 432 to fix the test piece 10 covering the opening 431. The target point P is disposed within the area of the opening 431. A first position adjuster 434 includes an X-position adjuster 434a and a Y-position adjuster 434b, which can move the top plate 43a with respect to the bottom plate 43b.

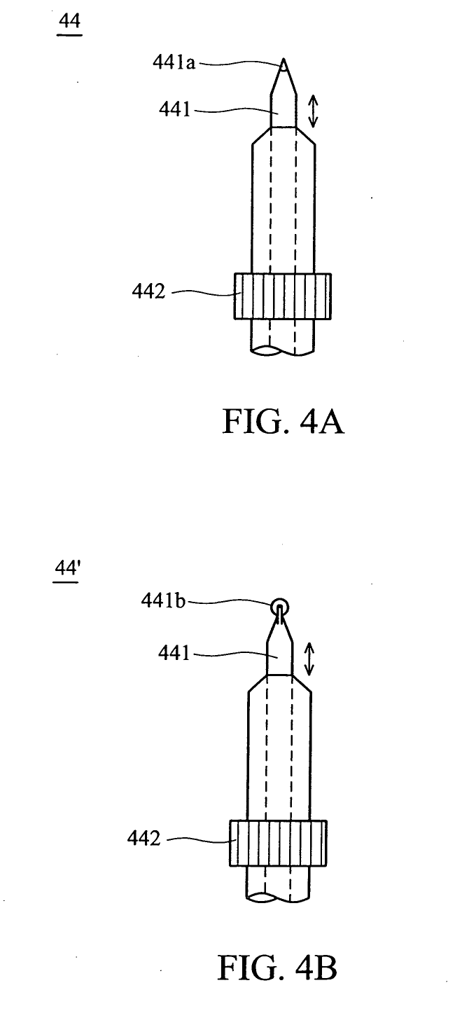

FIG. 4A shows a cutter with a diamond tip in the first embodiment. The cutter assembly 44 includes a second position adjuster 442 and a cutter 441 disposed thereon. The first preferred cutter 441 has a diamond tip 441a. When rotating the second position adjuster 442 to raise the cutter 441 the diamond tip 441a contacts the bottom surface of the test piece 10 clipped to the top plate 43a, and test piece 10 is moved with respect to the diamond tip 441a, forming notches for subsequent splitting. In FIG. 4B, the second preferred cutter 441 of the cutter assembly 44′ has a wheel knife 441b. The wheel knife 441b can only be used in a predetermined direction because of the fixed rotating direction. However, the notches formed by the wheel knife 441b are straight, such that the cross-section formed by the next splitting method can precisely cross the target point P.

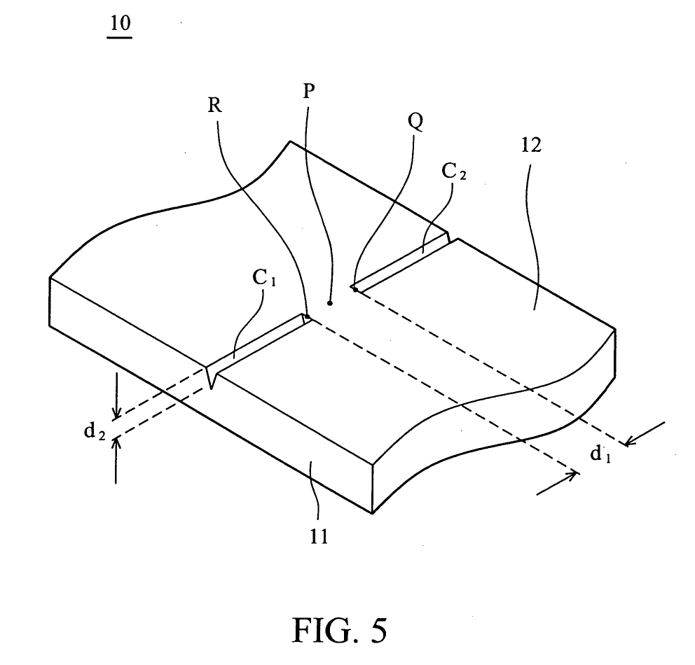

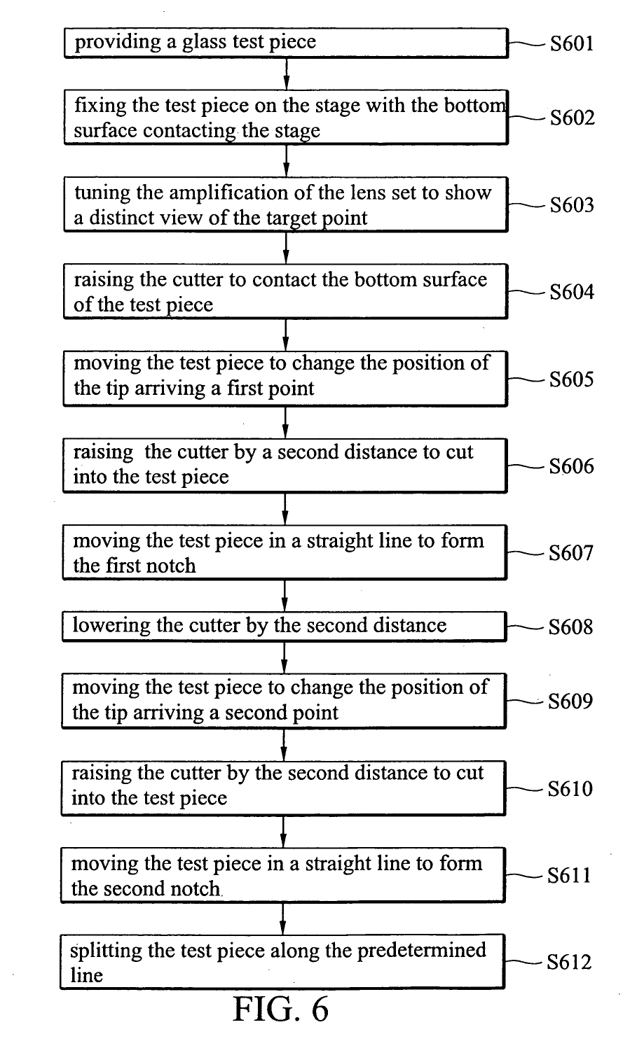

FIG. 5 is a schematic view of the test piece with notches, and FIG. 6 is a flowchart showing the test piece splitting method of the present invention. Referring to FIGS. 2-3 and 5-6, the present invention provides an operating method of the precise cutting device 40 to split a transparent test piece, such as a piece of the glass substrate of an LCD panel. First, the method includes the steps of providing a rectangular test piece of a proper size (S601). The test piece 10 has wiring layers (ITO) with a target point P requiring cross-section analysis. Next, the surface 12 of the wiring layers acts as a contact surface. The test piece 10 is fixed on the stage 43 by the clips 432 with the surface 12 contacting the top plate 43a (S602). The target point P is disposed within the range of the opening 431. A proper amplification of the lens set 41 is made and the height of the stage 43 is modified by the focus adjustment 433 to show a distinct view of the target point P (S603). Next, the cutter 441 is raised, and the tip of the cutter 441 passes through the opening 431, touching the surface 12 of the test piece 10 (S604). At the same time, the tip of the cutter 441 can be seen through the microscope 41. Next, the test piece 10 on the stage 43 is horizontally shifted by the X-position adjuster 434a and the Y-position adjuster 434b, such that the tip of the cutter 441 arrives at a first point Q (S605). The cutter 441 is raised a second distance d₂ to cut into the wiring layers 12 and the glass substrate 11 of the test piece 10 (S606). The test piece 10 fixed on the top plate 43a is moved in a straight line along the X-direction to form a first notch C₁ (S607). The cutter 441 is lowered a second distance d₂ (S608). Furthermore, the test piece 10 on the stage 43 is horizontally shifted again, such that the tip of the cutter 441 arrives at a second point R(S609). The cutter 441 is raised a second distance d₂ to cut into the wiring layers 12 and the glass substrate 11 of the test piece 10 (S610). The test piece 10 fixed on the top plate 43a is moved in a straight line along the X-direction to form a second notch C₂ (S611). Finally, the test piece 10 is split by hand or a predetermined mechanism along the first notch C₁ and the second notch C₂, acquiring a neat cross-section through the target point P.

In FIG. 5, the first point P and the second point Q are the closest points to the target point P of the first notch C₁ and the second notch C₂. The first point Q, the target point P and the second point R are aligned in the same line. The interval between the first point Q and the second point R are a first distance, about 1 mm to 50 μm. The depth of the first notch C, and the second notch C₂ is the second distance, about 1 mm to 50 μm.

According to the precise cutting device and the splitting method of the present invention, operators can split glass test pieces by modifying a standard inexpensive optical microscope. The splitting procedure can be finished in about 10 minutes, thus greatly shortened.

Furthermore, by the precise cutting device according to the present invention, one of each test piece has a neat cross-section passing exactly through the defect, or the target point. The cross-section can be scanned by an electron microscope, such that the image of each wiring layer can be easily distinguished, improving the accuracy of the cross-section analysis.

While the present invention has been described by way of example and in terms of the preferred embodiments, it is to be understood that the present invention is not limited to the disclosed embodiments. Instead, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A precise cutting device for splitting a test piece, comprising:
a microscope, comprising:
a support arm;
s a stage having an opening and movably connected to the arm to support the test piece; and
a lens set disposed on the top of the support arm, adjustable to show the microstructure of the test piece;
a cutter disposed under the stage of the microscope and passing through the opening to form notches on the surface of the test piece.

2. The precise cutting device as claimed in claim 1, wherein the stage has a clip to fix the test piece and a first position adjuster to shift the test piece horizontally within a predetermined area.

3. The precise cutting device as claimed in claim 1, further comprising:
a second position adjuster disposed under the stage, elevating the vertical position of the cutter assembled thereon.

4. The precise cutting device as claimed in claim 1, wherein the cutter has a diamond tip.

5. The precise cutting device as claimed in claim 1, wherein the cutter has a wheel knife at the tip of the cutter.

6. The precise cutting device as claimed in claim 1, further comprising:
an image sensor disposed on the lens set, sensing optical images and converting them into electronic signals; and
a monitor electrically connected to the image sensor and displaying the electronic signals.

7. The precise cutting device as claimed in claim 1, wherein the image sensor is a charge-coupled camera.

8. A test piece splitting method for a precise cutting device with a microscope and a cutter, the microscope having a stage with an opening, a lens set and a first position adjuster, the cutter having a tip and disposed under the stage of the microscope, the test piece splitting method comprising the steps of:
providing a test piece having a surface with a target point;
fixing the test piece to the stage with the surface contacting the stage and the target point disposed within the range of the opening;
adjusting the amplification of the lens set to show a distinct view of the target point;
forming a first notch and a second notch on the surface, wherein the first notch and the second notch are aligned with the target point in a predetermined line, and the distance between the neighboring end points of the first notch and the second notch is a first interval; and
splitting the test piece along the predetermined line.

9. The method as claimed in claim 8, wherein the first interval is within 1 mm to 50 μm.

10. The method as claimed in claim 8, further comprising the steps of:
changing the vertical position of the tip of the cutter to contact the surface;
moving the test piece disposed on the stage by the first position adjuster to change the position of the tip to arrive at a first point on the surface;
raising the cutter a second distance to cut into the test piece;
moving the test piece by the first position adjuster to form the first notch;
lowering the cutter the second distance;
moving the test piece by the first position adjuster to change the position of the tip to arrive at a second point on the surface;
raising the cutter the second distance to cut into the test piece; and
moving the test piece by the first position adjuster to form the second notch.

11. The method as claimed in claim 10, wherein the first point and the second point are the nearest points of the first notch and the second notch to the target point.

12. The method as claimed in claim 10, wherein the second distance is about 50 μm to 10 μm.
